(19) United States
(12) Patent Application Publication
(10) Pub. No.: US 2009/0207094 A1
(43) Pub. Date: Aug. 20, 2009

(54) CONNECTOR AND RADIO FREQUENCY APPARATUS

(76) Inventors: Hua YANG, Shenzhen (CN); Liming ZHAO, Shenzhen (CN); Ming ZHAO, Shenzhen (CN); Shengbin TAN, Shenzhen (CN); Zhoujian LI, Shenzhen (CN); Haowen XU, Shenzhen (CN); Hao LI, Shenzhen (CN); Hai WEN, Shenzhen (CN); Tao PU, Shenzhen (CN); Xiaohong ZHAO, Shenzhen (CN)

Correspondence Address: BRINKS HOFER GILSON & LIONE, P.O. BOX 10395, CHICAGO, IL, 60610, US

(21) Appl. No.: 12/430,502

(22) Filed: Apr. 27, 2009

Related U.S. Application Data
(63) Continuation of application No. PCT/CN2007/070634, filed on Sep. 5, 2007.

(30) Foreign Application Priority Data
Dec. 21, 2006 (CN) 200620173438.0

(51) Int. Cl. H01Q 1/00

(52) U.S. Cl. 343/904

(57) ABSTRACT

An antenna is connected to a connector disclosed in the present disclosure, and the connector has a clamping slot adapted to fix a radio remote unit (RRU). A clamping slot tight side may be set on the connector to fasten the RRU, and an RRU fastening hole may be set on the connector to fasten the RRU. An RF apparatus integrated with a connector is also disclosed. According to the present disclosure, the antenna and the RRU are fixed to the connector. This makes it unnecessary to provide additional spaces and supports for installing the RRU. Hence, the RRU can be installed in a proper position and the installation costs can be reduced. In addition, the distance between the antenna and the RRU is shortened. Thus, the cable (when necessary) between the antenna and the RRU is shorter than that in the prior art. This greatly reduces signal transmission losses.

### CROSS REFERENCE TO RELATED APPLICATIONS

This application is a continuation application of PCT/CN2007/070634, filed on Sep. 5, 2007, which claims priority to Chinese Patent Application No. 200620173438.0, filed with the Chinese Patent Office on Dec. 21, 2006 and entitled “Connector and Radio Frequency Apparatus integrated with the connector”, both of which are incorporated herein by reference in their entirety.

### FIELD OF THE DISCLOSURE

The present disclosure relates to machinery fields, and in particular, to a connector and a radio frequency apparatus comprising the connector.

### BACKGROUND OF THE INVENTION

A radio remote unit (RRU) that is connected to an antenna through a cable is located at the end of a radio access network. The RRU communicates with the antenna to process signals received by the antenna and provide the antenna with signals to be transmitted.

FIG. 1 shows the installation of an RRU and an antenna in the prior art. As shown in FIG. 1, an antenna 3 is installed on a pole 1, an RRU 4 is installed at the bottom of the pole 1, and the antenna 3 is connected to the RRU 4 through a long cable 2. The installation method in FIG. 1 has the following weaknesses:
1. A long cable is needed between the RRU and the antenna, increasing signal transmission losses,
2. Additional spaces and supports are needed to install the RRU, making it difficult to obtain a proper installation position and increasing installation costs.

### SUMMARY OF THE INVENTION

Embodiments of the present disclosure provide a connector and a radio frequency (RF) apparatus integrated with the connector to reduce installation costs and signal transmission losses.

A connector provided in an embodiment of the disclosure is adapted to fix an antenna, the connector has a clamping slot adapted to fix an RRU; and the antenna fixed to the connector can be connected to the RRU.

An RF apparatus integrated with a connector provided in an embodiment of the disclosure includes the connector, and an antenna and an RRU that are connected to the connector, in which the connector has a clamping slot adapted to fix the RRU, and the antenna fixed to the connector can be connected to the RRU.

The connector adapted to fix the antenna has a clamping slot adapted to fix the RRU so that the antenna and the RRU are fixed to the connector. This makes it unnecessary to provide additional spaces and supports for installing the RRU. Hence, the RRU can be installed in a proper position and the installation costs can be reduced. In addition, the distance between the antenna and the RRU is shortened. Thus, the cable (when necessary) between the antenna and the RRU is shorter than that in the prior art. This greatly reduces signal transmission losses.

### BRIEF DESCRIPTION OF THE DRAWINGS

FIG. 1 shows the installation of an RRU and an antenna in the prior art;

FIG. 2 shows a perspective view of a connector in an embodiment of the present disclosure;

FIG. 3 shows a front view of the connector shown in FIG. 2;

FIG. 4 shows a rear view of the connector shown in FIG. 2;

FIG. 5 shows a perspective view of an antenna in an embodiment of the present disclosure;

FIG. 6 shows the installation of an antenna and a connector in an embodiment of the present disclosure;

FIG. 7 shows a perspective view of the antenna and the connector that are installed according to FIG. 6;

FIG. 8 shows the installation of the RRU and the connector in a first embodiment of the present disclosure;

FIG. 9 shows a perspective view of the RRU and the connector that are installed according to FIG. 8;

FIG. 10 shows the installation of the RRU and the connector in a second embodiment of the present disclosure;

FIG. 11 shows a perspective view of the RRU and the connector that are installed according to FIG. 10;

FIG. 12 shows the installation of the RRU and the connector in a third embodiment of the present disclosure; and

FIG. 13 shows a perspective view of the RRU and the connector that are installed according to FIG. 12.

### DETAILED DESCRIPTION OF THE INVENTION

The present disclosure is described in detail by reference to the accompanying drawings and specific embodiments hereinafter.

An antenna is fixed to the connector provided in an embodiment of the present disclosure. The connector has a clamping slot adapted to place an RRU. An RF apparatus includes the connector provided in an embodiment of the disclosure, an antenna and an RRU fixed to the connector respectively, where the connector has the clamping slot adapted to place the RRU. In addition, a clamping slot tight side may be set on the connector to press a RRU tight side on the RRU, or the RRU may be fixed to an RRU fastening hole of the connector with a screw.

FIG. 2 shows a perspective view of the connector in accordance with an embodiment of the present disclosure. As shown in FIG. 2, the clamping slot 6 and the RRU fastening hole 7 are set on the front side of the connector 5. Multiple RRU fastening holes 7 may be set at any position outside the clamping slot 6. The RRU 4 may be placed and fastened in the clamping slot 6; and a screw may be tightened in the RRU 4 through the RRU fastening hole 7 to fix the RRU 4 to the connector 5.

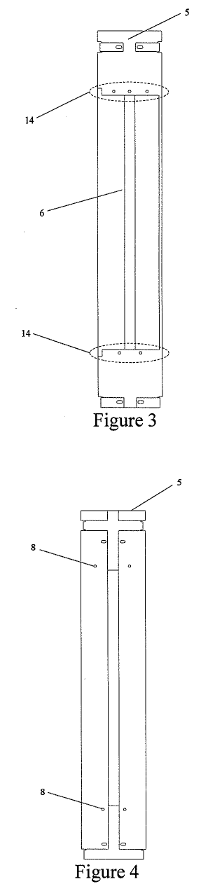

FIG. 3 shows the front view of the connector shown in FIG. 2. As shown in FIG. 3, the clamping slot 6 is set on the connector 5, and two clamping slot tight sides 14 are set at positions outside the two ends of the clamping slot 6 on the connector 5 respectively. An RRU fastening hole 7 is set on the clamping slot tight side 14.

FIG. 4 shows the rear view of the connector shown in FIG. 2. As shown in FIG. 4, an antenna fastening hole 8 is set on the rear side of the connector 5. A screw may be tightened to the antenna 3 through the antenna fastening hole 8 so that the antenna 3 can be fixed to the connector 5.

In practical applications, there may be multiple clamping slots 6, RRU fastening holes 8, and antenna fastening holes 8, and the positions of the antenna fastening holes 8 may be set on the rear side of the connector 5 freely. The positions of the RRU fastening holes 7 may be set on the clamping slot tight side 14 freely.

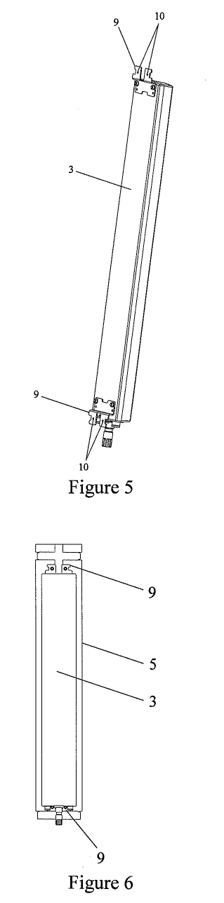

FIG. 5 shows the perspective view of the antenna. As shown in FIG. 5, the antenna 3 is connected to an antenna installation unit 9 through a screw. The antenna 3 may also be connected to the antenna installation unit 9 through soldering or plugging.

An antenna installation unit fastening hole 10 is also set on the antenna installation unit 9. In this case, after the antenna installation unit 9 contacts the rear side of the connector 5, the screw can be tightened in the antenna fastening hole 8 on the rear side of the connector 5 through the antenna installation unit fastening hole 10 of the antenna installation unit 9, and the antenna 3 can be fixed to the connector 5. The antenna 3 and the connector 5 may be also connected through soldering or plugging.

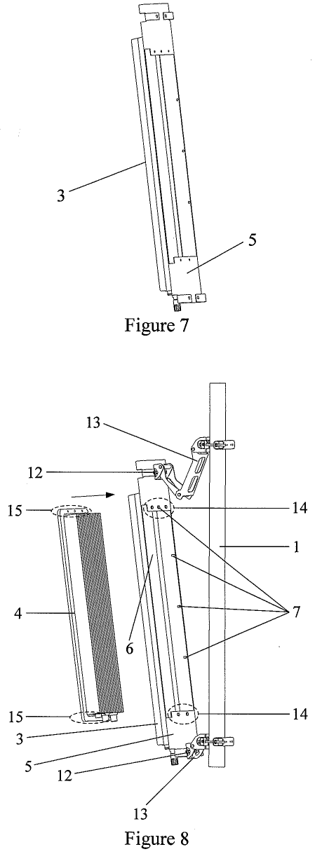

FIG. 6 shows the installation of the antenna and the connector in an embodiment of the present disclosure. As shown in FIG. 6, on the rear side of the connector 5, the antenna 3 and the connector 5 may be connected with a screw through the antenna installation unit 9. FIG. 7 shows the perspective view of the antenna 3 and the connector 5 that are installed according to FIG. 6.

FIG. 8 shows the installation of the RRU and the connector in the first embodiment of the present disclosure. As shown in FIG. 8, the RRU 4 may be pushed into the clamping slot 6 of the connector 5 from the side of the connector 5 so that the RRU 4 is clamped in the clamping slot 6 and fixed to the connector 5. To fasten the connection between the RRU 4 and the connector 5, an RRU tight side 15 may be set on the RRU 4, and a clamping slot tight side 14 may be set on the connector 5. In this case, when the RRU 4 is located in the clamping slot 6, the RRU tight side 15 can be located in the clamping slot 6 and the RRU tight side 15 presses the clamping slot tight side 14, ensuring that the RRU 4 is fixed to the connector 5.

The RRU fastening hole 7 may also be set on the clamping slot tight side 14 (see FIG. 2), and the screw may be tightened to the RRU tight side 15 through the RRU fastening hole 7 so as to fasten the connection between the RRU 4 and the connector 5.

In addition, the connector 5 may be connected to a hinge 13 through a bolt, and the hinge 13 is fixed to the pole 1, thus fixing the connector 5. Further, because the connector 5 is fixed to the pole 1 through the hinge 13, the antenna 3 and the RRU 4 that are installed on the connector 5 can be fixed to the pole 1 through the connector 5 and the hinge 13.

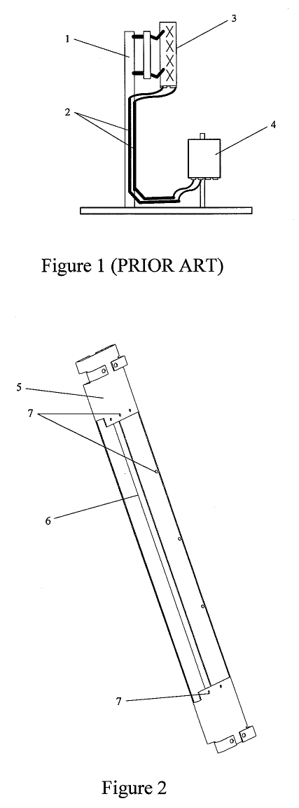

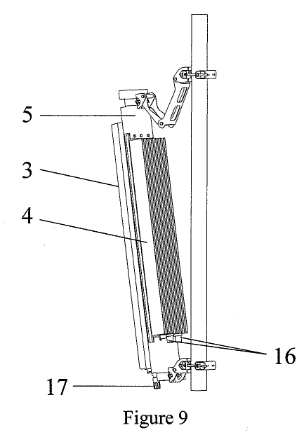

FIG. 9 shows a perspective view of the RRU and the connector that are installed according to FIG. 8. As shown in FIG. 9, the antenna 3 and the RRU 4 are fixed to the connector 5. Therefore, no additional spaces and supports are needed to install the RRU 4. Hence, the RRU 4 can be installed in a proper position and the installation costs can be reduced. In addition, compared with the distance in FIG. 1, the distance between the antenna 3 and the RRU 4 shown in FIG. 9 is shortened. Thus, the length of the cable (when necessary) between an antenna connecting terminal 17 of the antenna 3 and an RRU connecting terminal 16 of the RRU 4 is much shorter than that shown in FIG. 1. This greatly reduces the signal transmission losses.

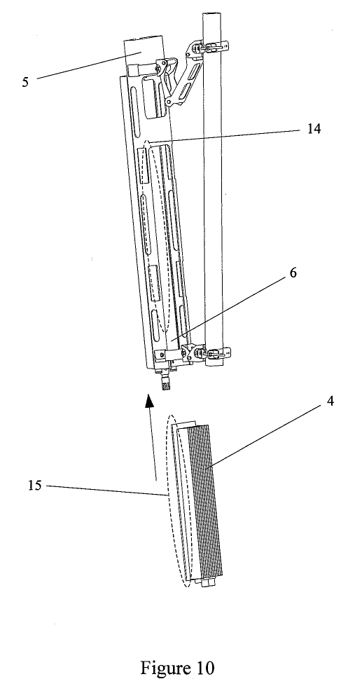

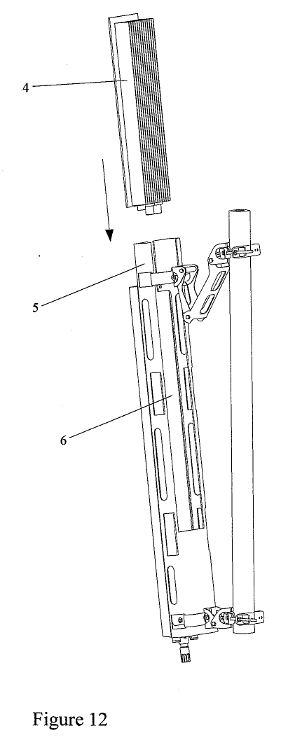

In practical applications, the RRU 4 and the connector 5 may be installed according to FIG. 10 and FIG. 12 besides FIG. 8.

FIG. 10 shows the installation of the RRU and the connector in the second embodiment of the present disclosure. As shown in FIG. 10, the RRU 4 may be pushed into the clamping slot 6 of the connector 5 from the bottom of the connector 5 so that the RRU 4 is clamped in the clamping slot 6 and fixed to the connector 5.

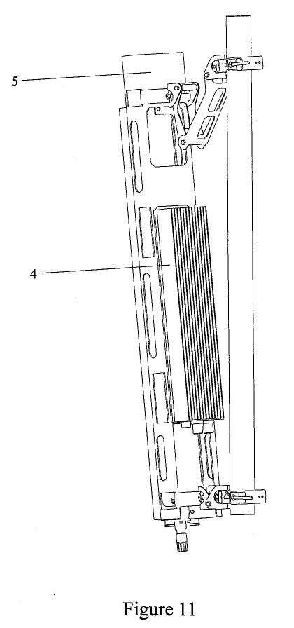

FIG. 11 shows a perspective view of the RRU and the connector that are installed according to FIG. 10. The RRU 4 and the connector 5 can be connected according to the installation mode shown in FIG. 10.

FIG. 12 shows the installation of the RRU and the connector in the third embodiment of the present disclosure. As shown in FIG. 12, the RRU 4 may be pushed into the clamping slot 6 of the connector 5 from the top of the connector 5 so that the RRU 4 is clamped in the clamping slot 6 and fixed to the connector 5.

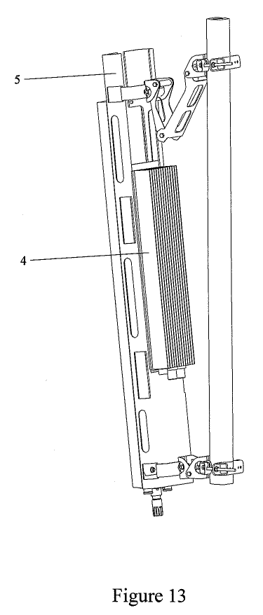

FIG. 13 shows a perspective view of the RRU and the connector that are installed according to FIG. 12. As shown in FIG. 13, the RRU 4 and the connector 5 can be connected according to the installation mode shown in FIG. 12.

It should be noted that the installation mode shown in FIG. 8 in which the RRU tight side 15 and the clamping slot tight side 14 are set to fasten the connection between the RRU 4 and the connector 5 may also be used in FIG. 10 to FIG. 13, and the RRU tight side 15 and the clamping slot tight side 14 may be set at any position so long as the connection between the RRU 4 and the connector is fastened. Similarly, the installation mode shown in FIG. 8 in which the RRU fastening hole 7 is set to fasten the connection between the RRU 4 and the connector 5 may also be used in FIG. 10 to FIG. 13, and the RRU fastening hole 7 may be set at any position so long as the connection between the RRU 4 and the connector are fastened.

In practice, the RRU 4 and the antenna 3 may be fixed on the same side of the connector 5. This may shorten the length of the cable between the RRU 4 and the antenna 3, thus reducing the signal transmission loss. If the RRU 4 and the antenna 3 are fixed on the same side of the connector 5, the preceding settings that are used to fasten the RRU 4 and the antenna 3 should be performed on the same side of the connector 5. In addition, the RRU 4 and the antenna 3 may be connected through the connector.

From the above embodiments, it can be seen that the connector and the RF apparatus integrated with the connector of the disclosure can integrate the RRU and the antenna for installation, thus reducing installation costs and signal transmission losses.

Although the present disclosure has been described in details with reference to the preferred embodiments, it should be understood by those with ordinary skilled in the art that various modifications or equivalent alternatives may be made to the present disclosure without departing from the spirit and scope of the present disclosure.

What is claimed is:

1. A connector adapted to fix an antenna, the connector comprising a clamping slot for placing a radio remote unit (RRU).

2. The connector of claim 1, wherein the connector further comprises a clamping slot tight side adapted to press an RRU tight side of the RRU, the clamping slot tight side is outside one end of the clamping slot.

3. The connector of claim 1, wherein the connector further comprises two clamping slot tight sides set at positions outside the two ends of the clamping slot respectively.

4. The connector of claim 3, wherein the connector further comprises a plurality of RRU fastening holes, the RRU fastening holes are located on the clamping slot tight sides of the connector.

5. The connector of claim 2, wherein the connector further comprises an RRU fastening hole, the RRU fastening hole is adapted to accommodate a screw to fasten the RRU on the connector.

6. The connector of claim 5, wherein the RRU fastening hole is located on the clamping slot tight side of the connector.

7. The connector of claim 6, wherein the clamping slot and the RRU fastening hole are set on a front side of the connector.

8. The connector of claim 1, wherein the RRU can be pushed into the clamping slot from the side of the connector, or the RRU can be pushed into the clamping slot from the bottom of the connector, or the RRU can be pushed into the clamping slot from the top of the connector.

9. The connector of claim 1, wherein the connector is further connected to a hinge, and the hinge is adapted to fix the connector.

10. The connector of claim 1, wherein the connector is connected to the antenna through a screw, or the connector is connected to the antenna through plugging.

11. A radio frequency (RF) apparatus comprising
a connector;
an antenna; and
an RRU,
wherein the antenna is fixed to the connector,
wherein the connector has a clamping slot adapted to place the RRU, and
wherein the antenna is connected to the RRU through a connecting member.

12. The apparatus of claim 11, wherein the apparatus further comprises an antenna installation unit, the antenna installation unit is fixed to the antenna.

13. The apparatus of claim 12, wherein an antenna installation unit fastening hole is set on the antenna installation unit, an antenna fastening hole is set on the connector, a screw can be tightened in the antenna fastening hole through the antenna installation unit fastening hole.

14. The apparatus of claim 11, wherein the connector further comprises a clamping slot tight side adapted to press an RRU tight side of the RRU, the clamping slot tight side is set at position outside one end of the clamping slot.

15. The apparatus of claim 14, wherein the connector further comprises an RRU fastening hole adapted to accommodate a screw to fasten the RRU on the connector.

16. The apparatus of claim 15, wherein the RRU fastening hole is located on the clamping slot tight side of the connector.

17. The apparatus of claim 16, wherein the clamping slot and the RRU fastening hole are set on a front side of the connector.

18. The apparatus of claim 11, wherein the connector further comprises two clamping slot tight sides set at positions outside the two ends of the clamping slot respectively.

19. The apparatus of claim 18, wherein the connector further comprises a plurality of RRU fastening holes, the RRU fastening holes are located on the clamping slot tight sides of the connector.

20. The apparatus of claim 11, wherein the RRU can be pushed into the clamping slot from the side of the connector, or the RRU can be pushed into the clamping slot from the bottom of the connector, or the RRU can be pushed into the clamping slot from the top of the connector.
